(19) United States
(12) Patent Application Publication
(10) Pub. No.: US 2009/0082889 A1
(43) Pub. Date: Mar. 26, 2009

(54) STORAGE APPARATUS AND STORAGE METHOD

(75) Inventors: Kazuhiro TAKASHIMA, Tokyo (JP); Hidehito IZAWA, Hanno-shi (JP); Yasukazu OHNO, Ome-shi (JP); Toshihiro MOROHOSHI, Kawasaki-shi (JP); Shigeo MORIMOTO, Hamura-shi (JP); Kenji KOYANO, Hanno-shi (JP); Tatsuo HIROSE, Hamura-shi (JP); Masao IWASAKI, Ome-shi (JP); Atsushi NAKAMURA, Hamura-shi (JP); Yasuhiro TAKAHASHI, Ome-shi (JP); Seiko KAWASHIMA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/208,613

(22) Filed: Sep. 11, 2008

(30) Foreign Application Priority Data
Sep. 26, 2007 (JP) 2007-250136

(51) Int. Cl. G06F 17/00

(52) U.S. Cl. 700/94

(57) ABSTRACT

According to one embodiment, a storage apparatus comprises storage devices, a first selection module configured to select a first storage device in accordance with selection made by a user, a determination module configured to determine whether or not the first storage device can store data, a second selection module configured to select a second storage device when the determination module determines that the first storage device cannot store data, and a storage control module configured to store data in the first storage device when the determination module determines that the first storage device can store data, and to store data in the second storage device when the determination module determines that the first storage device cannot store data.

### CROSS-REFERENCE TO RELATED APPLICATIONS

This application is based upon and claims the benefit of priority from Japanese Patent Application No. 2007-250136, filed Sep. 26, 2007, the entire contents of which are incorporated herein by reference.

### BACKGROUND

1. Field

One embodiment of the present invention relates to a storage apparatus and a storage method for appropriate data management.

2. Description of the Related Art

In recent years, even a portable terminal device such as a portable music player has become to be possible to receive and store a television broadcast program or to download a data file of moving picture data or the like from a network.

The terminal device stores the acquired data file or data of the broadcast program in built-in storage or external storage. However, built-in or external storage of the terminal device has a limit in a storage capacity. Data amount of a broadcast program is generally large; therefore, if contents stored in the storage are improperly managed, storing desired data may result in failure or data already stored in the storage may be accidentally deleted.

Jpn. Pat. Appln. KOKAI Publication No. 2006-311067 discloses an electronic camera apparatus which, when backing up pictures stored in a hard disk drive to another storage medium, can select a storage medium as a storage destination.

According to the above technique, when an external storage medium selected as the storage destination is not inserted in the camera apparatus, when a storage capacity of the storage destination is not sufficiently assured, or when inhibition of storage is set in the storage destination, data may not appropriately be stored. Furthermore, this technique does not cope with automatic data storage such as programmed recording of a broadcast program.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a schematic configuration of a storage apparatus according to an embodiment of the present invention;

FIG. 2 is an exemplary external view showing an example of an appearance of the storage apparatus;

FIG. 3 is an exemplary view showing an example of a storage flag stored in a flag storage area;

FIG. 4 is an exemplary flowchart of program storing processing according to a first embodiment of the present invention;

FIG. 5 is an exemplary view showing an example of a selection menu screen displayed on an LCD;

FIG. 6 is an exemplary flowchart of programmed recording processing according to a second embodiment of the present invention;

FIG. 7 is an exemplary view showing an example of data contents stored in a programmed recording table;

FIG. 8 is an exemplary flowchart of data acquisition processing according to a third embodiment of the present invention; and

FIG. 9 is an exemplary view showing data contents stored in a programmed acquisition table.

### DETAILED DESCRIPTION

Various embodiments according to the invention will be described hereinafter with reference to the accompanying drawings. In general, according to one embodiment of the invention, a storage apparatus comprises storage devices, a first selection module configured to select a first storage device from the storage devices in accordance with selection made by a user, a determination module configured to determine whether or not the first storage device selected by the first selection module can store data, a second selection module configured to select a second storage device from the storage devices when the determination module determines that the first storage device cannot store data, and a storage control module configured to store data in the first storage device when the determination module determines that the first storage device can store data, and to store data in the second storage device when the determination module determines that the first storage device cannot store data.

Embodiments according to the present invention will now be explained hereinafter with reference to the accompanying drawings.

### First Embodiment

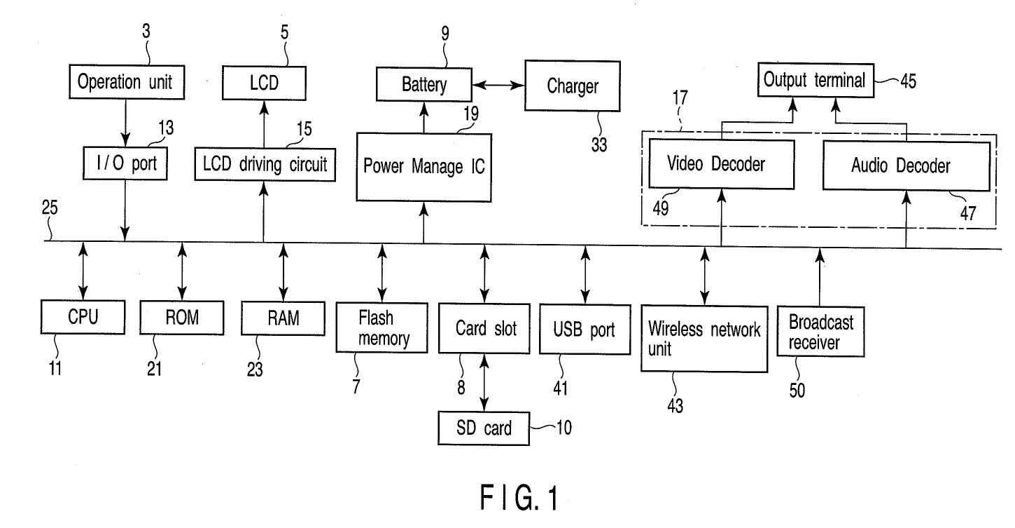

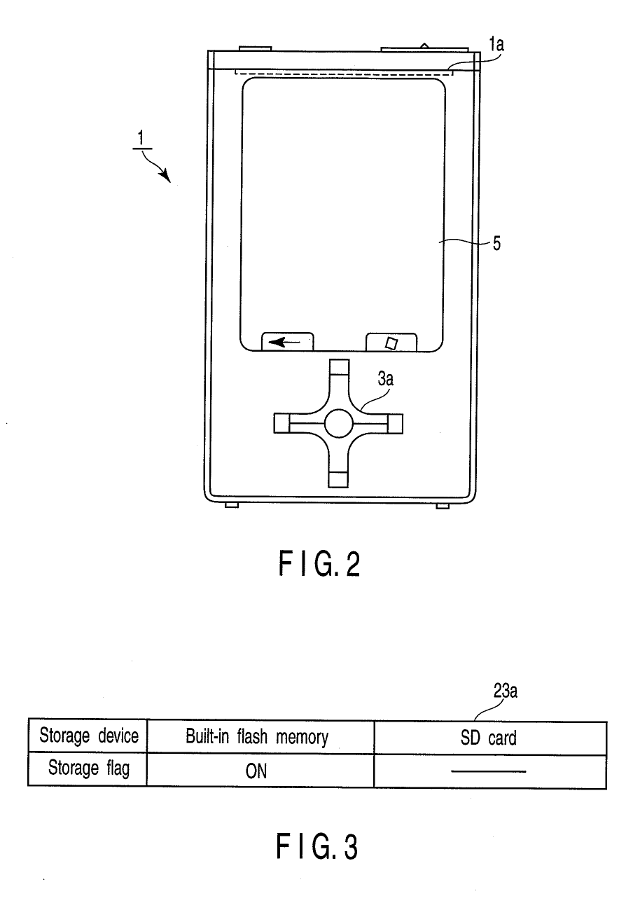

FIG. 1 is an exemplary block diagram showing an example of an electronic configuration of a portable multimedia reproducing apparatus (player) 1 according to a first embodiment of the present invention. FIG. 2 is an exemplary view showing an example of an appearance of the player 1.

The player 1 includes a CPU 11 which is a main controller. The CPU 11 controls operations of respective portions in the player 1. The respective portions in the player 1 are connected with the CPU 11 through a bus.

A user can input an operation instruction and a selection instruction by operating an operation unit 3. A control signal corresponding to the operation of the operation unit 3 by the user is supplied to the CPU 11 from an input/output (I/O) port 13. A liquid crystal display (LCD) 5 displays picture data of a moving picture, a still picture, or textual information. The textual information to be displayed on the LCD 5 includes a name of a data file being currently reproduced, lyrics data included in the (audio) data file being currently reproduced and others. An LCD driving circuit 15 drives the LCD 5 under the control of the CPU 11.

The operation unit 3 includes a multifunction button 3a depicted in FIG. 2. The multifunction button 3a is used to enter an instruction to start or stop reproducing audio data or picture data and to enter a selection instruction from a menu screen, and so on. For example, when a center button of the multifunction button 3a is pressed, an instruction to start or stop storing data is transmitted to the CPU 11.

Furthermore, when any one of up, down, right and left direction buttons is pressed, a control instruction to change an item displayed on the LCD 5 is transmitted to the CPU 11 in accordance with pressing of the button.

The player 1 includes an antenna unit 1a that is used for wireless communication with an external device or for receiving terrestrial digital broadcasting. It is preferable to provide the antenna unit 1a at a non-metal portion in the player 1 such as circumference of the LCD 5 or the vicinity of a main power switch (not shown) on a side surface of the player 1.

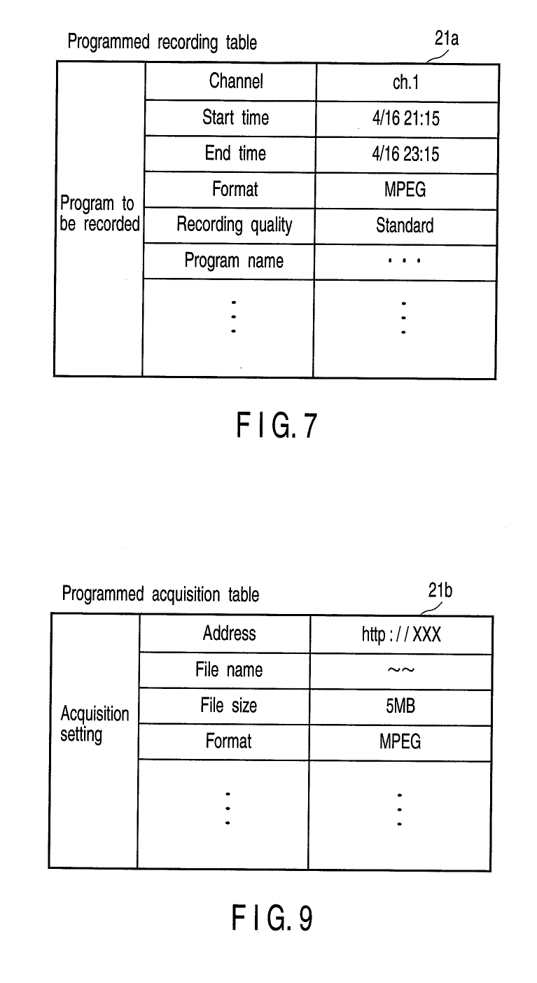

A ROM 21 and a RAM 23 are connected to the CPU 11 via a control bus 25. The ROM 21 prestores program data which is to be executed by the CPU 11 to control operations of the player 1. Such storage areas are provided in the RAM 23 as a programmed recording table 21a (see FIG. 7) for storing setting information of a broadcast program which is programmed to be recorded and a programmed acquisition table 21a (see FIG. 9) for storing setting information of data to be acquired from a network.

The RAM 23 is utilized as a work memory by the CPU 11. The RAM 23 temporarily holds control information associated with a control signal and a certain amount of data read from a built-in flash memory 7. A flag storage area 23a depicted in FIG. 3 is also provided in the RAM 23. In data storing processing, which will be explained later, a storage device for which a storage flag is set is utilized as a data storage destination. In the example shown in FIG. 3, a storage flag is set for the built-in flash memory, accordingly, data will be stored in the built-in flash memory 7.

A battery (secondary battery) 9 is utilized as a power source when the player 1 is portably carried on. A power control IC 19 manages power provided from the battery 9, i.e., a given voltage and an allowable current. A charger 33 is connected with the battery 9. In this embodiment, from a power input unit is input a direct voltage which is pressure-reduced and converted into approximately 5V by an external power source device (not shown) to downsize the player 1. The charger 33 may be configured so as to directly accept a commercial power supply (100V AC).

The built-in flash memory 7 has a storage capacity of several gigabytes to several tens of gigabytes, and stores picture data or audio data. The built-in flash memory 7 may be attachable to and removable from the player 1. A hard disk drive (HDD) may be provided in place of or in addition to the built-in flash memory 7.

An SD card 10 can be inserted into a card slot 8. The CPU 11 can store picture data or audio data in the SD card 10 through the slot 8. Further, the CPU 11 can also read and reproduce picture data or audio data stored in the SD card 10. Any other storage medium may be connected to the card slot 8 in place of the SD card 10.

The built-in flash memory 7 and the SD card 10 store previously compressed content data such as audio data, picture data or video data. A system such as MP3 or WMA is used to compress audio data, a system such as JPEG, GIF, or BMP-RLE is used to compress picture data, and a system such as WMV or MPEG is used to compress video data.

The CPU 11 executes a given reproduction program prestored in the ROM 21 to reproduce a data file such as an audio data file or a picture data file stored in the built-in flash memory 7 or in the SD card 10. The reproduction program for data files may be stored in the built-in flash memory 7 in advance.

An output unit 17 converts picture data or audio data into an analog output under the control of the CPU 11. An output terminal 45 is used for an ordinary analog output.

An audio decoder 47 which is provided in the output unit 17 demodulates audio data into an analog signal and sends the analog signal to the output terminal 45. In addition, a video decoder 49 which is provided in the output unit 17 performs digital-to-analog conversion on a video signal and outputs the converted video signal to the output terminal 45. Headphones, speakers having an amplifying function, a monitor device, or a picture receiver may be connected to the output terminal 45, and an audio output or a video output can be heard or viewed. An audio output from the output terminal 45 may be input to an amplification device (not shown), and a speaker (not shown) may be connected to the amplification device to obtain a larger audio volume.

A Universal Serial Bus (USB) port 41 and a wireless network unit (communication unit) 43 are also connected with the CPU 11.

The player 1 can be connected with an external device (not shown) through the USB port 41 and send data to and receive data from the external device. For example, picture data or audio data is supplied to the player 1 from the external device such as a personal computer (PC) through the USB port 41. Furthermore, picture data or audio data stored in the player 1 may be supplied to the external device through the USB port 41. Audio data may be transmitted through the USB port 41 from the player 1 to the external device such as a USB speaker or a device which is dedicated to audio reduction and containing a semiconductor memory therein (e.g., USB flash memory player). The USB port 41 is also used to input a music/audio signal from the external device, e.g., a microphone.

The wireless network unit 43 is utilized for connecting with a wireless local area network (wireless LAN). Connecting to the wireless LAN is possible when the player 1 is placed within a certain distance range from an access point, which receives electric waves from the wireless LAN.

A broadcast receiver 50 is utilized for receiving terrestrial digital broadcasting for mobile objects (one-segment broadcasting). A broadcast signal received by the antenna unit 1a is transferred to the broadcast receiver 50. The broadcast receiver 50 performs tuning and demodulation on the digital broadcast signal received by the antenna unit 1a. The CPU 11 applies predetermined decoding processing to the broadcast signal received by the broadcast receiver 50 to convert the signal into a reproducible format.

Data storing processing to be executed by the player 1 will now be explained.

The player 1 can acquire data from a network through the wireless network unit 43. Moreover, the player 1 can also acquire broadcast program data through the broadcast receiver 50. Such data is stored in the built-in flash memory 7 or the SD card 10.

In this embodiment, a user can select either the built-in flash memory 7 or the SD card 10 as a storage destination to store the data.

Hereinafter, a description will be given as to processing of storing a broadcast program which is being received through the antenna unit 1a and the broadcast receiver 50.

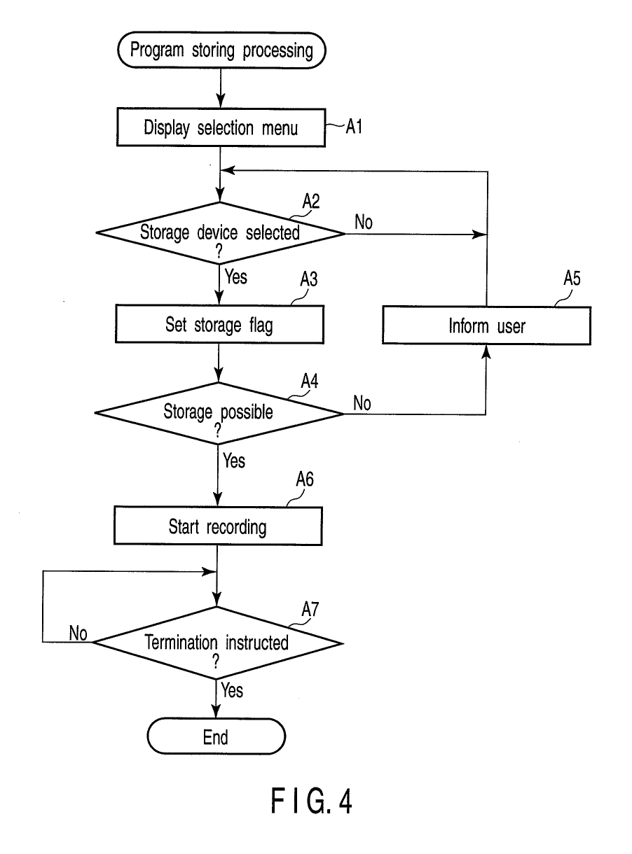

When a user operates the multifunction button 3a and instructs the CPU 11 to start recording a currently receiving broadcast program, program storing processing depicted in FIG. 4 is activated.

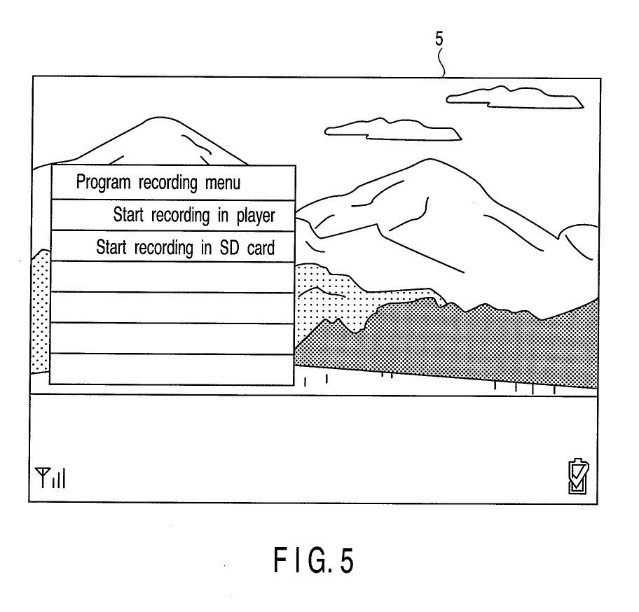

When the program storing processing is activated, the CPU 11 displays on the LCD 5 a menu screen for selecting a storage device as shown, for example, in FIG. 5 (block A1). Then, the CPU 11 waits until the user selects a storage device to store program data from the displayed selection menu (block A2).

The user can select a storage device as a storage destination to store a program from the displayed selection menu. When it is desired to store a broadcast program in the built-in flash memory 7, “Start recording in player” is to be selected from the selection menu depicted in FIG. 5. Alternatively, when it is desired to store the program in the SD card 10, “Start recording in SD card” is to be selected.

When the user selects one of the storage devices (YES in block A2), the CPU 11 sets a storage flag for the selected storage device in the flag storage area 23a based on the selection (block A3).

Then, the CPU 11 determines whether or not it is possible to store data into the selected storage device for which the storage flag is set (block A4).

When it is inhibited to write over the selected storage device, when a storage capacity of the selected storage device is insufficient, or when the selected storage device is not actually attached to the player 1, storing data is not possible.

When it is not possible to store data in the selected storage device (NO in block A4), the CPU 11 displays a message on the LCD 5 to inform the user of a fact that the selected storage device cannot store the broadcast program (block A5).

Subsequently, the user can select the other storage device as the storage destination by operating the multifunction button 3a (block A2). Alternatively, a new storage device provided with a sufficient storage capacity may be newly inserted into the card slot 8 and this new storage device may be selected as the storage destination to store the program data. When the user newly selects a storage device (YES in block A2), the storage flag of the newly selected storage device is set (block A3), and whether data can be written in the newly selected storage device or not is determined (block A4).

When the selected storage device can afford to store data (YES in block A4), storing the broadcast program is started (block A6). That is, the CPU 11 starts storing the broadcast program data being currently received into the storage device for which the storage flag is set.

Storing the broadcast program data is continued until the user enters termination instruction of storing data by operating the multifunction button 3a (block A7). When the user instructs termination of storing data (YES in block A7), the program storing processing is terminated.

In this embodiment, the user can arbitrarily select a storage device in which program data is to be stored from the storage devices. The selected storage device can be designated based on the storage flag. When data cannot be stored in the selected storage device, it is possible to urge the user to change a storage device to store the program data.

Therefore, such failure in program recording can be avoided that a desired program failed to be stored or data already stored in a storage device is accidentally deleted.

Other embodiments according to the present invention will now be explained. In the following embodiments, the same portions as the first embodiment are denoted by the same reference numerals as the first embodiment and detailed explanation thereof will be omitted. A configuration of the other embodiments is shown in the block diagram of FIG. 1.

### Second Embodiment

In the first embodiment, storing a broadcast program which is being currently received is explained. In the second embodiment, a case of programmed recording of a broadcast program will be explained.

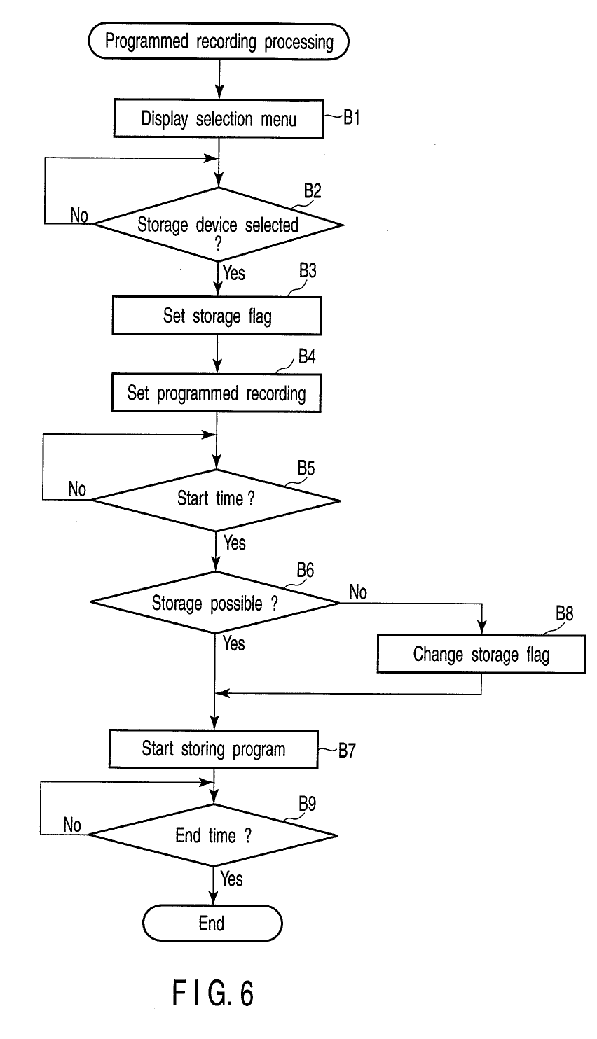

When a user instructs the CPU 11 by operating the multifunction button 3a to start programmed recording processing for recording a broadcast program, programmed recording processing depicted in FIG. 6 is activated.

When the programmed recording processing is activated, a CPU 11 displays on the LCD 5 a menu screen for selecting a storage device as shown, for example, in FIG. 5 (block B1). Then, the CPU 11 waits until the user selects a storage device to store program data from the displayed selection menu (block B2).

The user can select a storage device as a storage destination to store a program to be recorded from the displayed selection menu. When it is desired to store a broadcast program in the built-in flash memory 7, “Start recording in player” is to be selected from the selection menu shown in FIG. 5. On the other hand, when it is desired to store the program in the SD card 10, “Start recoding in SD card” is to be selected.

When the user selects one of the storage devices (YES in block B2), the CPU 11 sets a storage flag for the selected storage device in a flag storage area 23a based on the selection (block B3).

Then, recording of a broadcast program is programmed and the broadcast program to be recorded is set (block B4). The user inputs information of the broadcast program to be recorded in accordance with a guidance screen displayed on the LCD 5. The information of the broadcast program includes for example, a channel, a start time, an end time, a data format for storage and others of the program. The input data is stored in a programmed recording table 21a as shown in FIG. 7, for example.

After the setting of the programmed recording is executed, the CPU 11 waits until the start time of the broadcast program which is set and stored in the programmed recording table 21a (block B5).

When the set start time has come (YES in block B5), the CPU 11 determines whether or not it is possible to store data in the selected storage device for which the storage flag is set (block B6). When it is inhibited to write over the selected storage device, when the storage capacity of the selected storage device is insufficient, or when the selected storage device is not installed in the player 1, storing data is not possible.

When it is possible to store data in the selected storage device (YES in block B6), storing the broadcast program which is programmed to be recorded is started (block B7). That is, the CPU 11 receives data of the broadcast program that is programmed to be recorded based on the information stored in the programmed recording table 21a, and stores the data of the broadcast program into the storage device for which the storage flag is set.

On the other hand, when it is not possible to store data in the selected storage device (NO in block B6), the CPU 11 selects the other storage device as the storage destination and changes a storage flag of the newly selected storage device so that the storage flag is set (block B8).

Then, the CPU 11 starts storing the broadcast program which is programmed to be recorded (block B7). That is, based on the information stored in the programmed recording table 21a, the CPU 11 causes the broadcast receiver 50 to receive program data which is programmed to be recorded, and stores the program data in the storage device for which the storage flag set.

Recording the program data is continued until the end time stored in the programmed recording table 21a has come (block B9). When the end time stored in the programmed recording table 21a has come (YES in block B9), the programmed recording processing is terminated.

In this embodiment, the user can arbitrarily select a storage device to store data of a program which is programmed to be recorded from the storage devices. The selected storage device can be designated based on the storage flag. When a start time of the recording set in the programmed recording table 21a has come, it is determined whether or not the selected storage device can afford to store data. When it is determined that the selected storage device cannot store the program data, the CPU 11 automatically changes the storage destination to store the program data, and the program data is stored in the changed storage destination.

Therefore, even when programmed recording of a broadcast program is executed, failure in program recording resulting from that the selected storage device is actually not inserted in the player 1 or that the storage capacity of the selected storage device is insufficient can be avoided.

In the present embodiment, a standby state continues until a start time set in the programmed recording table 21a has come (block B5). However, during the standby state, other processing may be executed or a power of the player 1 may be turned off. It can be configured so that even in such cases, a timer contained in the CPU 11 executes time measurement and the processing is resumed when the start has come.

### Third Embodiment

The player 1 can be connected with an access point of a wireless LAN through the wireless network unit 43 and acquire data from the network. For executing wireless communication, the player 1 should be placed within a given distance range from the access point. A case of storing data acquired through the network will be explained in the third embodiment.

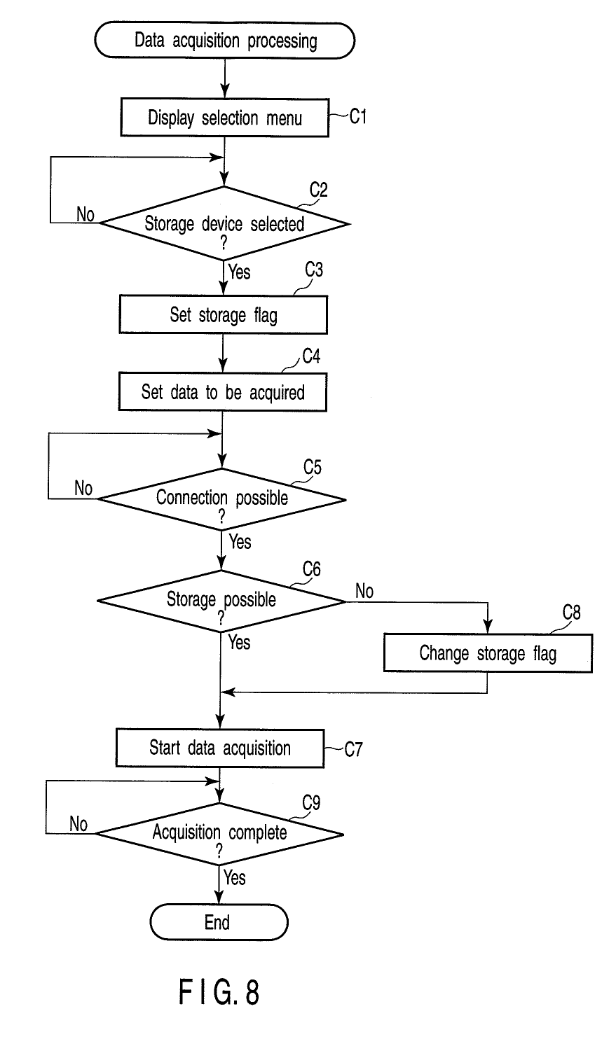

When a user instructs the CPU 11 by operating the multifunction button 3a to acquire data from the network, a data acquisition processing shown in FIG. 8 is activated.

When the data acquisition processing is activated, the CPU 11 displays on the LCD 5 the selection menu screen for selecting a storage device as shown in FIG. 5 (block C1). Then, the CPU 11 waits until the user selects a storage device to store acquired data from the displayed selection menu (block C2).

The user can select a storage device as a storage destination to store the acquired data from the displayed selection menu. When it is desired to store the acquired data in the built-in flash memory 7, “Start recording in player” is to be selected from the selection menu shown in FIG. 5. When it is desired to store the acquired data in the SD card 10, “Start recording in SD card” is to be selected.

When the user selects one of the storage devices (YES in block C2), the CPU 11 sets a storage flag for the selected storage device in the flag storage area 23a based on the selection (block C3).

Thereafter, setting of data which is to be acquired is executed, and data which the user desires is set (block C4). The user inputs information of the data to be acquired in accordance with a guidance screen displayed-on the LCD 5. The information of the data to be acquired includes an address of a server of the data on the network, a file name of the data, a storage format for storing the data in the selected storage device, and others. The input information is stored in a programmed acquisition table 21b as shown in FIG. 9, for example.

After the setting of data acquisition is executed, the CPU 11 determines whether or not the access point is accessible through the wireless network unit 43 (block C5). In order to wirelessly communicate with the access point, the player 1 is required to be placed at a point where electric waves from the access point can be received. As the player 1 is a portable multimedia reproducing apparatus, the player 1 may be distanced from the access point while the user carries the player 1, and the player 1 may not connect wirelessly to the access point.

When the player 1 cannot connect to the access point (NO in block C5), data cannot be acquired. The CPU 11 is set in an acquisition programmed state, that is, the CPU 11 arranges that the data will be acquired if it becomes possible. While the user carries the player 1 in the acquisition programmed state, when the player 1 reaches a position where communication with the access point is available, data acquisition comes to be possible. Note that the CPU 11 can monitor constantly a state of communication between the wireless network unit 43 and the access point.

When it is detected that the access point has become accessible (YES in block C5), the CPU 11 determines whether or not it is possible to store data in the selected storage device for which the storage flag set (block C6). When it is inhibited to write over the selected storage device, when the storage capacity of the selected storage device is insufficient, or when the selected storage device is not installed in the player 1, the data cannot be stored.

When it is possible to store data in the selected storage device (YES in block C6), acquiring the data from the network and storing the acquired data are started based on the information stored in the programmed acquisition table 21b (block C7).

On the other hand, when it is not possible to store data in the selected storage device (NO in block C6), the CPU 11 selects the other storage device as the data storage destination and changes a storage flag of the newly selected storage device so that the storage flag is set (block C8).

Then, the CPU 1 starts acquiring and storing the data based on the information stored in the programmed acquisition table 21b (block C7).

When the acquisition and the storage of the data are completed (YES in block C9), the data acquisition processing is terminated.

In this embodiment, the user can arbitrarily select from the storage devices a storage device to store data which is to be acquired from the network. The selected storage device can be designated based on the storage flag. When the player 1 is distanced from the access point and cannot be connected with the network, the acquisition programmed state is set. In the case where the user carries the player 1 in the acquisition programmed state, when the player 1 reaches a position from which the access point is accessible, the CPU 11 determines whether or not it is possible to store the data in the selected storage device. When it is determined that the selected storage device cannot store the data, the CPU 11 automatically changes the storage destination to store the data, acquires the data from the network and stores the acquired data.

Therefore, even in the case of acquiring data from the network while the user carries the player 1, it is possible to avoid failure in data storing resulting from that the selected storage device is not inserted in the player 1 or that the storage capacity of the selected storage device is insufficient.

In the first to third embodiments, description is given on an example in which a storage device to store data is selected from the two storage devices, i.e., the built-in flash memory 7 and the SD card 10. However, the player 1 may include three or more storage devices, and a storage device to store data may be selected from these storage devices. Also in such a case, a storage device to store data as a storage destination can be managed based on the storage flag.

Modification

The present invention is not restricted to the foregoing embodiments, and can be modified and embodied in many ways.

In block A1 of FIG. 4, block B1 of FIG. 6, and block C1 of FIG. 8, the selection menu screen shown in FIG. 5 is displayed and causes the user to select a storage device in which data is to be stored. In addition, a remaining storage capacity of each storage device may be calculated and displayed.

In a case of recording or programmed recording of a broadcast program, recordable time may be displayed as follows, for example. The user can obtain indication of recording capacities.

“Start recording in player (recording for WX minutes is possible)”

“Start recording in SD card (recording for YZ minutes is possible)”

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one or more computers, such as servers. While the various modules are illustrated separately, they may share some or all of the same underlying logic or code.

What is claimed is:

1. A storage apparatus comprising:
storage devices;
a first selection module configured to select a first storage device from the storage devices in accordance with selection made by a user;
a determination module configured to determine whether or not the first storage device selected by the first selection module can store data;
a second selection module configured to select a second storage device from the storage devices when the determination module determines that the first storage device cannot store the data; and
a storage control module configured to store the data in the first storage device when the determination module determines that the first storage device can store the data, and to store the data in the second storage device when the determination module determines that the first storage device cannot store the data.

2. The storage apparatus of claim 1, further comprising a start condition setting module configured to set a condition to start storing the data, wherein the determination module is configured to determine whether or not the first storage device can store the data when the condition to start storing is satisfied.

3. The storage apparatus of claim 1, further comprising a start time setting module configured to set a time to start storing the data, wherein the determination module is configured to determine whether or not the first storage device can store the data when the time to start storing the data has come.

4. The storage apparatus of claim 1, further comprising a broadcast receiving module configured to receive broadcasting data, wherein the storage control module is configured to store the broadcasting data in the first storage device when the determination module determines that the first storage device can store the data, and to store the broadcasting data in the second storage device when the determination module determines that the first storage device cannot store the data.

5. The storage apparatus of claim 4, further comprising a start time setting module configured to set a time to start storing the data, wherein the determination module is configured to determine whether or not the first storage device can store the data when the time to start storing the data has come.

6. The storage apparatus of claim 1, further comprising a communication module configured to connect to a network and receive data from the network, wherein the storage control module is configured to store the data received from the network in the first storage device when the determination module determines that the first storage device can store the data, and to store the data acquired from the network in the second storage device when the determination module determines that the first storage device cannot store the data.

7. The storage apparatus of claim 6, further comprising a detection module configured to detect a connection state between the communication module and the network, wherein the determination module is configured to determine whether or not the first storage device can store the data when the detection module detects that the communication module is connected to the network.

8. The storage apparatus of claim 1, wherein the second selection module is configured to select the second storage device in accordance with instruction made by the user.

9. The storage apparatus of claim 1, further comprising a display module configured to display data, and a display control module configured to cause the display module to display a list of the storage devices, and wherein the first selection module is configured to select the first storage device in accordance with the selection made by the user from the storage devices displayed in the list by the display control module.

10. The storage apparatus of claim 9, wherein the display control module is configured to cause the display module to display storage capacities of the storage devices.

11. A storage apparatus comprising:
storage devices;
a selection module configured to select a storage device from the storage devices in accordance with selection made by a user;
a determination module configured to determine whether or not the storage device selected by the selection module can store data; and
an informing module configured to cause a display module to display a message when the determination module determines that the storage device cannot store the data.

12. A storage method comprising:
selecting a storage device from storage devices in accordance with selection made by a user;
determining whether or not the selected storage device can store data; and
displaying a message when it is determined that the storage device cannot store the data.
